(19) United States
(12) Patent Application Publication
(10) Pub. No.: US 2026/0208454 A1
(43) Pub. Date: Jul. 23, 2026

(54) METHODS OF PERFORMING GAP RESIN INFUSION

(71) Applicant: The Boeing Company, Arlington, VA (US)

(72) Inventor: Stephen L. Belcher, Sheffield (GB)

(21) Appl. No.: 19/032,197

(22) Filed: Jan. 20, 2025

(51) Int. Cl. B29C 70/48; B29C 35/04; B29C 70/54; B29L 31/30

(52) U.S. Cl. CPC B29C 70/48; B29C 35/041; B29C 70/54; B29C 2035/043; B29L 2031/3076

(57) ABSTRACT

Methods of performing gap resin infusion are presented. A resin is injected into a resin infusion chamber of a resin infusion mold comprising a first portion and a second portion while maintaining a temperature differential between the first portion and the second portion. An infused preform is formed by forcing the resin into a dry fiber preform located in the resin infusion chamber while maintaining the temperature differential between the first portion and the second portion of the resin infusion mold.

### BACKGROUND INFORMATION

### 1. Field

The present disclosure relates generally to composite manufacturing and more specifically to resin infusion in composite manufacturing.

### 2. Background

In resin transfer molding (RMT), thermal masses and heat transfer coefficient of metallic tooling limit the heating rate of the internal surface temperature and component. Oil heaters, which are conventionally used, don't provide high ramp rates for high rate processing. As a result, low heating rates and excessive cycle times result from using existing oil heaters in large metallic tooling for composite RTM processing.

Therefore, it would be desirable to have a method and apparatus that takes into account at least some of the issues discussed above, as well as other possible issues. For example, it would be desirable to reduce cycle times for resin transfer molding.

### SUMMARY

An embodiment of the present disclosure provides a method of performing gap resin infusion. A resin is injected into a resin infusion chamber of a resin infusion mold comprising a first portion and a second portion while maintaining a temperature differential between the first portion and the second portion. An infused preform is formed by forcing the resin into a dry fiber preform located in the resin infusion chamber while maintaining the temperature differential between the first portion and the second portion of the resin infusion mold.

Another embodiment of the present disclosure provides a method of performing gap resin infusion. A dry fiber preform is infused with resin to form an infused preform by lowering a first portion of a resin infusion mold towards a second portion of the resin infusion mold while the first portion and the second portion are held at a temperature differential set based on a type of resin. The infused preform is held within the resin infusion mold while the first portion and the second portion are held at the temperature differential.

Yet another embodiment of the present disclosure provides a method of performing gap resin infusion. A first dry fiber preform is infused with resin in a resin infusion mold comprising a first portion and a second position, wherein the first portion and the second portion are held at a temperature differential to form a first infused preform. The first infused preform is removed from the resin infusion mold. A second dry fiber preform is infused with resin in the resin infusion mold while the first portion and the second portion of the resin infusion mold are held at a second temperature differential to form a second infused preform. The temperature differential is maintained between the first portion and the second portion of the resin infusion mold between infusion steps.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of a cross-sectional view through a resin infusion mold prior to resin infusion in accordance with an illustrative embodiment;

FIG. 4 is an illustration of a cross-sectional view through a resin infusion mold during resin injection in accordance with an illustrative embodiment;

FIG. 5 is an illustration of a cross-sectional view through a resin infusion mold during resin infusion in accordance with an illustrative embodiment;

FIG. 6 is an illustration of a cross-sectional view through a resin infusion mold following resin infusion in accordance with an illustrative embodiment;

FIG. 7 is a flowchart of a method of performing gap resin infusion in accordance with an illustrative embodiment;

FIG. 8 is a flowchart of a method of performing gap resin infusion in accordance with an illustrative embodiment;

FIG. 9 is a flowchart of a method of performing gap resin infusion in accordance with an illustrative embodiment;

FIG. 10 is an illustration of an aircraft manufacturing and service method in a form of a block diagram in accordance with an illustrative embodiment; and

FIG. 11 is an illustration of an aircraft in a form of a block diagram in which an illustrative embodiment may be implemented.

### DETAILED DESCRIPTION

The illustrative examples recognize and take into account several considerations. The illustrative examples recognize and take into account that “high rate” resin for aerospace applications may utilize a temperature “ramp” during the curing phase of the RTM process in order to deliver the desired mechanical properties. The illustrative examples recognize and take into account that resins for aerospace applications can have lower tolerance and higher technical demands during curing in comparison to other industries due to the desired mechanical properties.

The illustrative examples recognize and take into account that a “ramp” could feasibly be in the range of 30 degrees Celsius. The illustrative examples recognize and take into account that a ramp of approximately 30 degrees Celsius can produce a significant time penalty. The illustrative examples further recognize and take into account that a ramp of approximately 30 degrees Celsius results in an undesirably large heat energy consumption due to the mass of the molds. In some illustrative examples, the molds can be in the region of 50-60 tons.

The illustrative examples recognize and take into account that both the time penalty and heat energy consumption are highly undesirable in production. The illustrative examples recognize and take into account that both the time penalty and heat energy consumption will negate options to also manufacture the molds from cheaper steel materials than the aerospace standard of Invar.

The illustrative examples recognize and take into account that two part tooling systems use separate oil heating loops, meaning that they can be preheated to different temperatures. The illustrative examples provide methods of performing gap resin infusion with a resin infusion mold having a temperature differential between two mold halves.

The illustrative examples recognize and take into account that aerospace resins can use heat ramps to enable full material properties. The illustrative examples recognize and take into account that using traditional resin infusion processes, the production is too slow. The illustrative examples enable higher rate processing using existing equipment. The illustrative examples avoid having to heat up the tooling using standard temperature ramps. The illustrative examples delivers high rate output of composite components with low capital expenditure and energy reductions.

In some of the illustrative examples, the bottom tool portion is cooler while the upper tool portion has a higher temperature. In some of the illustrative examples, when the resin infusion mold is open, the lower temperature bottom tool will contain the resin during infusion. In some of the illustrative examples, once the gap is closed, the higher temperature top tool will come into contact with the composite and provide the thermal energy to raise the composite temperature rapidly, enabling higher rate production for RTM curing.

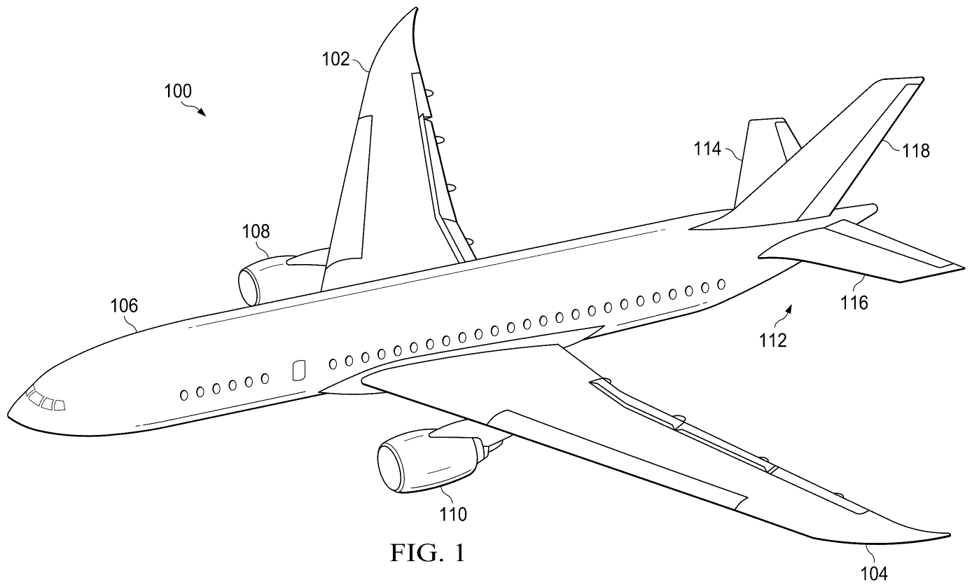

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have components formed using resin transfer infusion of the illustrative examples. In some illustrative examples, at least of portion of at least one of wing 102, wing 104, or body 106 can be manufactured using the methods of the illustrative examples.

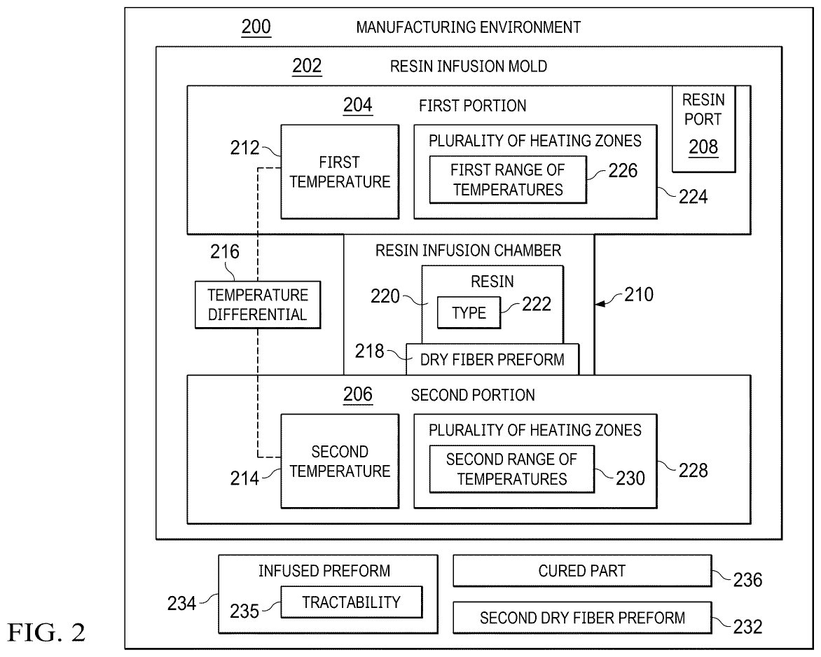

Turning now to FIG. 2, an illustration of a block diagram of a manufacturing environment is depicted in accordance with an illustrative embodiment. At least a portion of a composite structure of aircraft 100 can be manufactured in manufacturing environment 200.

Resin infusion mold 202 comprises first portion 204 and second portion 206 configured to seal to form resin infusion chamber 210. In some illustrative examples, first portion 204 and second portion 206 are a first half and a second half of resin infusion mold 202. In some illustrative examples, first portion 204 can be referred to as a first half of resin infusion mold 202. In some illustrative examples, second portion 206 can be referred to as a second half of resin infusion mold 202. Dry fiber preform 218 is present in resin infusion chamber 210 to receive resin 220. In this illustrative example, resin 220 is injected into resin infusion mold 202 through resin port 208. In this illustrative example, resin port 208 is present in first portion 204 of resin infusion mold 202. First portion 204 can be either an upper mold or a lower mold. First portion 204 is run at first temperature 212. In some illustrative examples, first portion 204 comprises plurality of heating zones 224. In these illustrative examples, first plurality of heating zones 224 is run at first range of temperatures 226. First range of temperatures 226 can be set based on a design of dry fiber preform 218. In some illustrative examples, first range of temperatures 226 can be set based on a range of thicknesses in dry fiber preform 218.

Second portion 206 can be either an upper mold or a lower mold. Second portion 206 is run at second temperature 214. Second temperature 214 is different from first temperature 212. Temperature differential 216 is the difference between first temperature 212 and second temperature 214. In some illustrative examples, second portion 206 comprises plurality of heating zones 228. In these illustrative examples, second plurality of heating zones 228 is run at second range of temperatures 230. Second range of temperatures 230 can be set based on a design of dry fiber preform 218. In some illustrative examples, second range of temperatures 230 can be set based on a range of thicknesses in dry fiber preform 218.

In some illustrative examples, first temperature 212 is greater than second temperature 214. In some illustrative examples, an upper mold portion of first portion 204 or second portion 206 is run at a higher temperature than the lower mold portion. In some illustrative examples, the upper mold portion is used to contact dry fiber preform 218 from one side in order to deliver an increased cure temperature as resin infusion mold 202 is fully closed.

First temperature 212 and second temperature 214 are set based on type 222 of resin 220. In some illustrative examples, the upper mold portion of either first portion 204 or second portion 206 runs at a substantially constant 170 degrees Celsius. In some illustrative examples, the lower mold portion runs at a substantially constant 140 degrees Celsius. Values of first temperature 212, second temperature 214, and temperature differential 216 are selected based on a desired level of curing following infusion of resin 220 into dry fiber preform 218. In other illustrative examples, the upper mold portion runs at a lower temperature than a lower mold portion.

In some illustrative examples, resin infusion mold 202 closing delivers contact between a higher temperature mold portion and dry fiber preform 218, heating dry fiber preform 218 from its initial lower temperature without needing to alter the temperature of either mold portion. When the upper mold is run at a higher temperature, the higher temperature mold briefly contacts injected resin 220. When the upper mold is run at a higher temperature, dry fiber preform 218 is in contact with the lower temperature mold portion.

After infusing resin 220 into dry fiber preform 218, the preform can be referred to as infused preform 234. After infusing resin 220 into dry fiber preform 218, infused preform 234 is maintained in resin infusion chamber 210 to increase tractability 235. Tractability 235 is increased due to temperature differential 216. In some illustrative examples, temperature differential 216 between first temperature 212 and second temperature 214 increases the rigidity of resin 220. In some illustrative examples, infused preform 234 is held in resin infusion chamber 210 to partially cure resin 220 in infused preform 234. In some illustrative examples, infused preform 234 is held in resin infusion chamber 210 to fully cure resin 220 and result in cured part 236.

In some illustrative examples, after improving tractability 235 of infused preform 234, infused preform 234 is removed from resin infusion mold 202. In some illustrative examples, after improving tractability 235 of infused preform 234 by curing, cured part 236 is removed from resin infusion mold 202.

In some illustrative examples, after removing an infused preform or cured part, another dry fiber preform is placed into resin infusion mold 202. In some illustrative examples, after removing an infused preform or cured part, temperature differential 216 is maintained for resin infusion mold 202. In some illustrative examples, second dry fiber preform 232 is placed into resin infusion chamber 210 after removal of infused preform 234. In some illustrative examples, second dry fiber preform 232 can be infused with resin in resin infusion mold 202 while resin infusion mold 202 maintains temperature differential 216.

By maintaining temperature differential 216 between first portion 204 and second portion 206, the time between processing dry fiber preforms is significantly reduced. By maintaining temperature differential 216 between first portion 204 and second portion 206, resin infusion mold 202 does not use a lengthy cool down between preforms.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

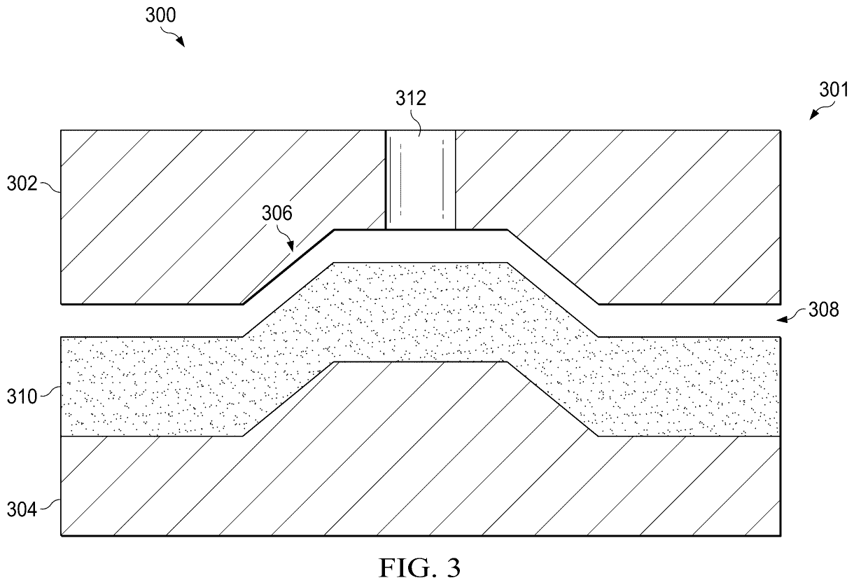

Turning now to FIG. 3, an illustration of a cross-sectional view through a resin infusion mold prior to resin infusion is depicted in accordance with an illustrative embodiment. Resin infusion mold 301 in view 300 can be a physical implementation of resin infusion mold 202 of FIG. 2.

In view 300, resin infusion mold 301 comprises first portion 302 and second portion 304 forming resin infusion chamber 306. Although seals are depicted in view 300, view 300 is a view of a portion of resin infusion mold 301. In operation, seals are present to seal resin infusion chamber 306 for pressure control. During operation, vacuum can be pulled in resin infusion chamber 306 to infuse resin into dry fiber preform 310 in resin infusion chamber 306. In this illustrative example, gap 308 is present between dry fiber preform 310 and first portion 302.

In this illustrative example, resin port 312 is present in first portion 302. Resin infusion port 312 can be positioned in any desirable location in resin infusion mold 301 depending upon at least a shape of dry fiber preform 310.

In view 300, first portion 302 is held at a first temperature while second portion 304 is held at a different second temperature. The temperature differential between first portion 302 and second portion 304 can be used to improve tractability of the resulting infused fiber preform.

In some illustrative examples, first portion 302 can comprise a plurality of heating zones maintaining a first range of temperatures. In some illustrative examples, second portion 304 can comprise a plurality of heating zones maintaining a second range of temperatures.

In some illustrative examples, the first temperature of first portion 302 is higher than the second temperature of second portion 304. The temperature differential between the first temperature and the second temperature is selected to allow for desirable resin flow during injection and resin infusion and improving tractability following infusion.

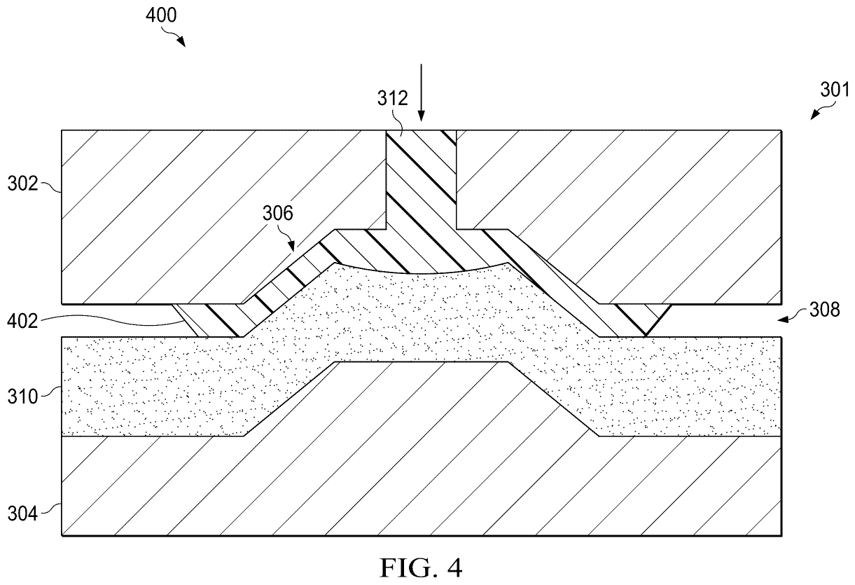

Turning now to FIG. 4, an illustration of a cross-sectional view through a resin infusion mold during resin injection is depicted in accordance with an illustrative embodiment. In view 400, resin 402 is injected into resin infusion mold 301. Resin 402 is injected into gap 308 through resin port 312.

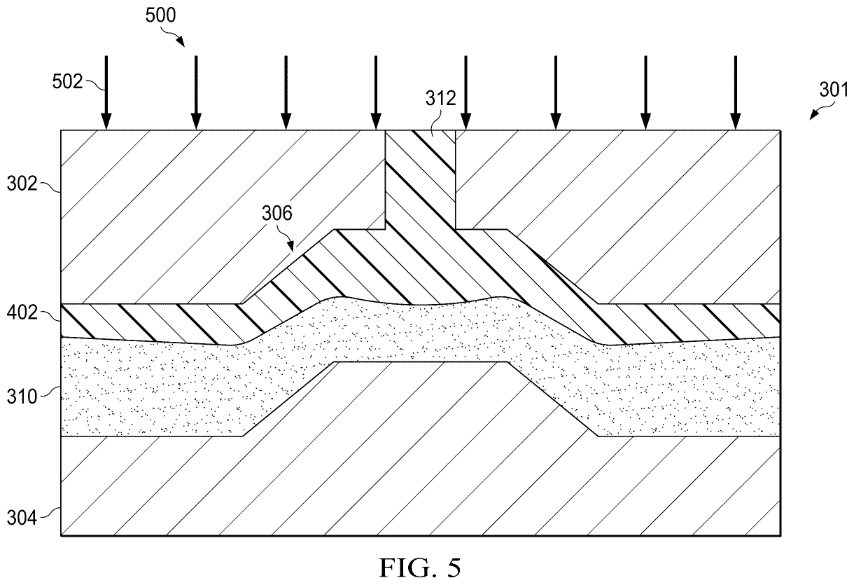

Turning now to FIG. 5, an illustration of a cross-sectional view through a resin infusion mold during resin infusion is depicted in accordance with an illustrative embodiment. In view 500, first portion 302 moves in direction 502 towards second portion 304 to infuse resin 402 into dry fiber preform 310.

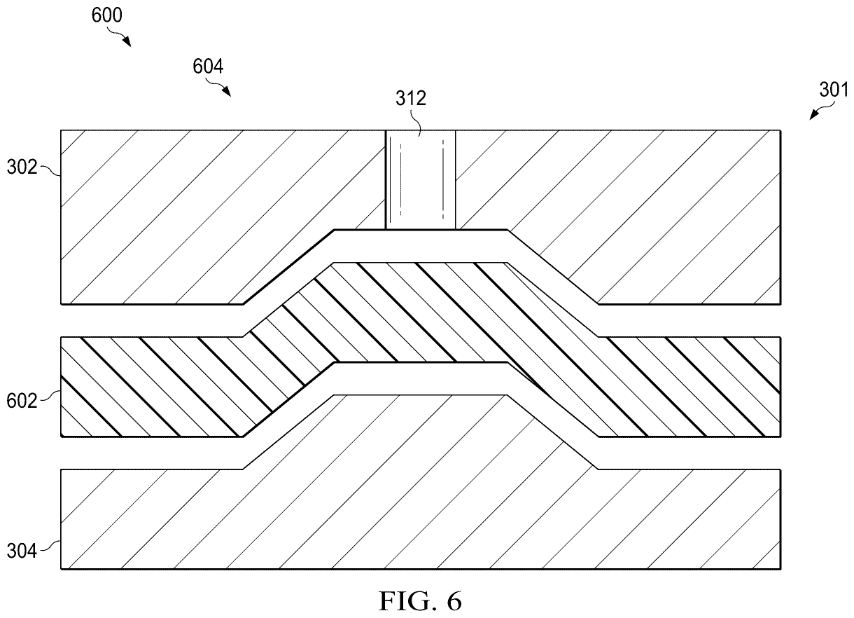

Turning now to FIG. 6, an illustration of a cross-sectional view through a resin infusion mold following resin infusion is depicted in accordance with an illustrative embodiment. In view 600, infused preform 602 is removed from resin infusion mold 301. In view 600, resin infusion mold 301 is in open position 604 and is no longer sealed. In some illustrative examples, infused preform 602 is partially cured. In some illustrative examples, infused preform 602 is fully cured.

In some illustrative examples, first temperature of first portion 302 is substantially maintained after opening resin infusion mold 301. In some illustrative examples, second temperature of second portion 304 is substantially maintained after opening resin infusion mold 301.

By substantially maintaining the temperatures of first portion 302 and second portion 304, time between infusing preforms can be reduced. By substantially maintaining the temperatures of first portion 302 and second portion 304, costs can be reduced.

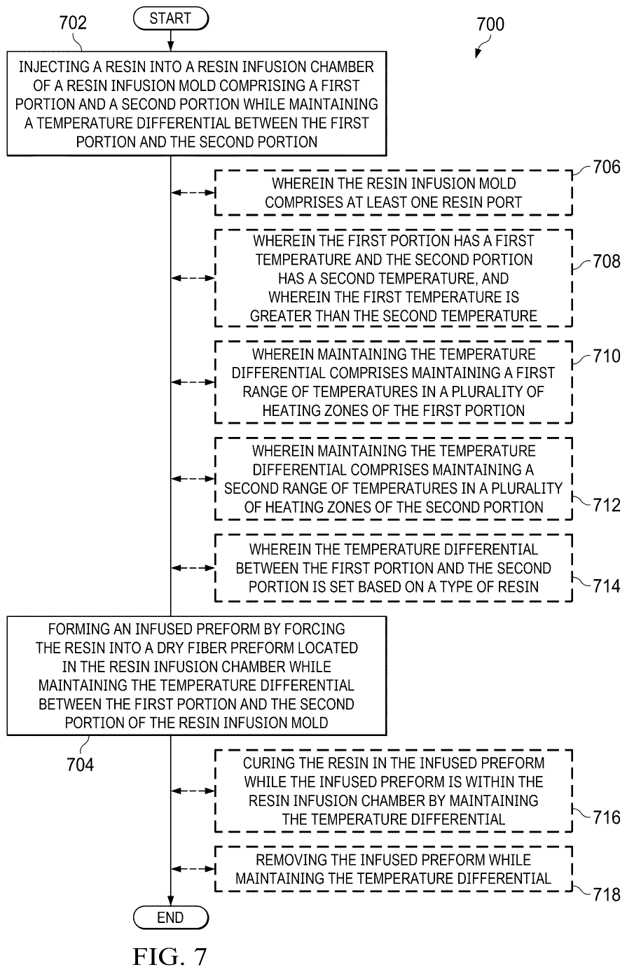

Turning now to FIG. 7, a flowchart of a method of performing gap resin infusion is depicted in accordance with an illustrative embodiment. Method 700 can be performed to form at least a portion of a composite component of aircraft 100 of FIG. 1. Method 700 can be performed using resin infusion mold 202 of FIG. 2. Method 700 can be performed using resin infusion mold 301 of FIGS. 3-6.

Method 700 injects a resin into a resin infusion chamber of a resin infusion mold comprising a first portion and a second portion while maintaining a temperature differential between the first portion and the second portion (operation 702). Method 700 forms an infused preform by forcing the resin into a dry fiber preform located in the resin infusion chamber while maintaining the temperature differential between the first portion and the second portion of the resin infusion mold (operation 704). Afterwards, method 700 terminates.

In some illustrative examples, method 700 removes the infused preform while maintaining the temperature differential (operation 718). In some illustrative examples, method 700 maintains the temperature differential following removal of the infused preform. In some illustrative examples, method 700 maintains the temperature differential during subsequent infusion steps for subsequent preforms.

In some illustrative examples, the resin infusion mold comprises at least one resin port (operation 706). In some illustrative examples, the first portion of the resin infusion mold comprises the at least one resin port. In some illustrative examples, an upper half of the resin infusion mold comprises the at least one resin port. In some illustrative examples, introducing the resin comprises introducing the resin through the at least one resin port.

In some illustrative examples, the first portion has a first temperature and the second portion has a second temperature, and wherein the first temperature is greater than the second temperature (operation 708).

In some illustrative examples, maintaining the temperature differential comprises maintaining a first range of temperatures in a plurality of heating zones of the first portion (operation 710). In some illustrative examples, maintaining the temperature differential comprises maintaining a second range of temperatures in a plurality of heating zones of the second portion (operation 712).

In some illustrative examples, method 700 cures the resin in the infused preform while the infused preform is within the resin infusion chamber by maintaining the temperature differential (operation 716). In some illustrative examples, method 700 partially cures the resin in the infused preform while the infused preform is within the resin infusion chamber by maintaining the temperature differential.

In some illustrative examples, the temperature differential between the first portion and the second portion is set based on a type of resin (operation 714). In some illustrative examples, parts comprising the same type of resin are infused sequentially through the resin infusion mold while the resin infusion mold maintains the temperature differential.

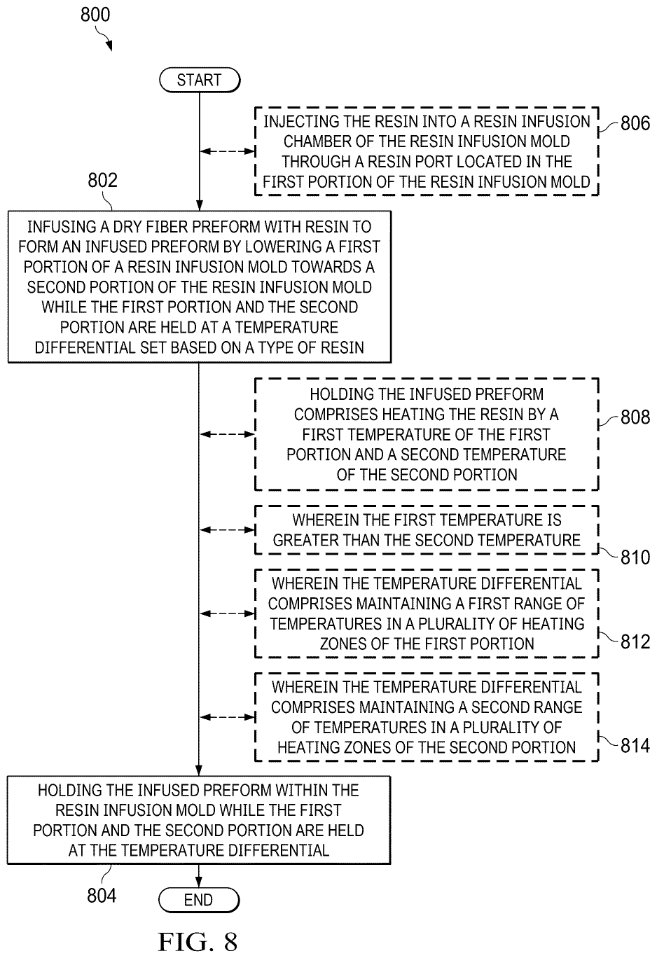

Turning now to FIG. 8, a flowchart of a method of performing gap resin infusion is depicted in accordance with an illustrative embodiment. Method 800 can be performed to form at least a portion of a composite component of aircraft 100 of FIG. 1. Method 800 can be performed using resin infusion mold 202 of FIG. 2. Method 800 can be performed using resin infusion mold 301 of FIGS. 3-6.

Method 800 infuses a dry fiber preform with resin to form an infused preform by lowering a first portion of a resin infusion mold towards a second portion of the resin infusion mold while the first portion and the second portion are held at a temperature differential set based on a type of resin (operation 802). Method 800 holds the infused preform within the resin infusion mold while the first portion and the second portion are held at the temperature differential (operation 804). Afterwards, method 800 terminates.

In some illustrative examples, method 800 injects the resin into a resin infusion chamber of the resin infusion mold through a resin port located in the first portion of the resin infusion mold (operation 806). In other illustrative examples, the resin can be introduced into the resin infusion chamber of the resin infusion mold through a resin port in the second portion of the resin infusion mold.

In some illustrative examples, holding the infused preform within the resin infusion mold while the first portion and the second portion are held at the temperature differential increases tractability of the infused preform. In some illustrative examples, holding the infused preform comprises heating the resin by a first temperature of the first portion and a second temperature of the second portion (operation 808). In some illustrative examples, increasing the tractability comprises heating the resin by a first temperature of the first portion and a second temperature of the second portion. In some illustrative examples, heating the resin by the first temperature can at least partially cure the resin. In some illustrative examples, heating the resin by the first temperature increase the rigidity of the resin infused preform.

In some illustrative examples, the first temperature is greater than the second temperature (operation 810). In some illustrative examples, the temperature differential comprises maintaining a first range of temperatures in a plurality of heating zones of the first portion (operation 812). In some illustrative examples, the temperature differential comprises maintaining a second range of temperatures in a plurality of heating zones of the second portion (operation 814).

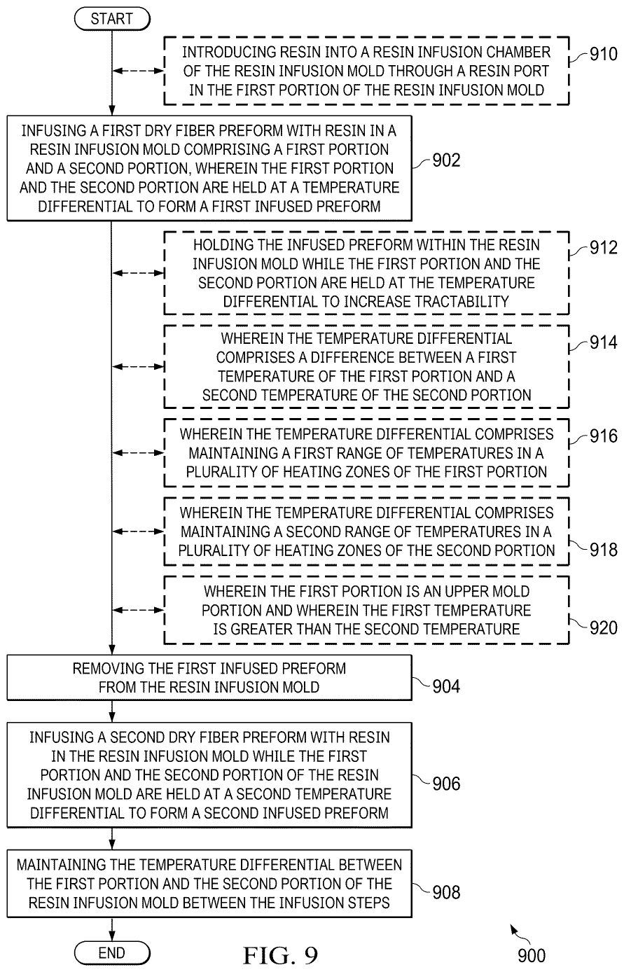

Turning now to FIG. 9, a flowchart of a method of performing gap resin infusion is depicted in accordance with an illustrative embodiment. Method 900 can be performed to form at least a portion of a composite component of aircraft 100 of FIG. 1. Method 900 can be performed using resin infusion mold 202 of FIG. 2. Method 900 can be performed using resin infusion mold 301 of FIGS. 3-6.

Method 900 infuses a first dry fiber preform with resin in a resin infusion mold comprising a first portion and a second portion, wherein the first portion and the second portion are held at a temperature differential to form a first infused preform (operation 902). Method 900 removes the first infused preform from the resin infusion mold (operation 904). Method 900 infuses a second dry fiber preform with resin in the resin infusion mold while the first portion and the second portion of the resin infusion mold are held at a second temperature differential to form a second infused preform (operation 906). Method 900 maintains the temperature differential between the first portion and the second portion of the resin infusion mold between infusion steps (operation 908). Afterward, method 900 terminates.

In some illustrative examples, the temperature differential is the same as the second temperature differential. In some illustrative examples, the temperature differential and the second temperature differential are different based on a different type of resin used for the infusion of the second dry fiber preform.

In some illustrative examples, method 900 introduces resin into a resin infusion chamber of the resin infusion mold through a resin port in the first portion of the resin infusion mold (operation 910). In some illustrative examples, pressure is used to send the resin into the resin infusion chamber. In some illustrative examples, introducing resin into the resin infusion chamber is referred to as injecting resin into the resin infusion chamber. In some illustrative examples, method 900 holds the infused preform within the resin infusion mold while the first portion and the second portion are held at the temperature differential to increase tractability (operation 912). In some illustrative examples, the temperature differential comprises a difference between a first temperature of the first portion and a second temperature of the second portion (operation 914).

In some illustrative examples, the temperature differential comprises maintaining a first range of temperatures in a plurality of heating zones of the first portion (operation 916). In some illustrative examples, the temperature differential comprises maintaining a second range of temperatures in a plurality of heating zones of the second portion (operation 918).

In some illustrative examples, the first portion is an upper mold portion and wherein the first temperature is greater than the second temperature (operation 920).

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, each of operation 706 through operation 718 may be optional. As another example, each of operation 806 through operation 814 may be optional. Additionally, each of operation 910 through operation 920 may be optional.

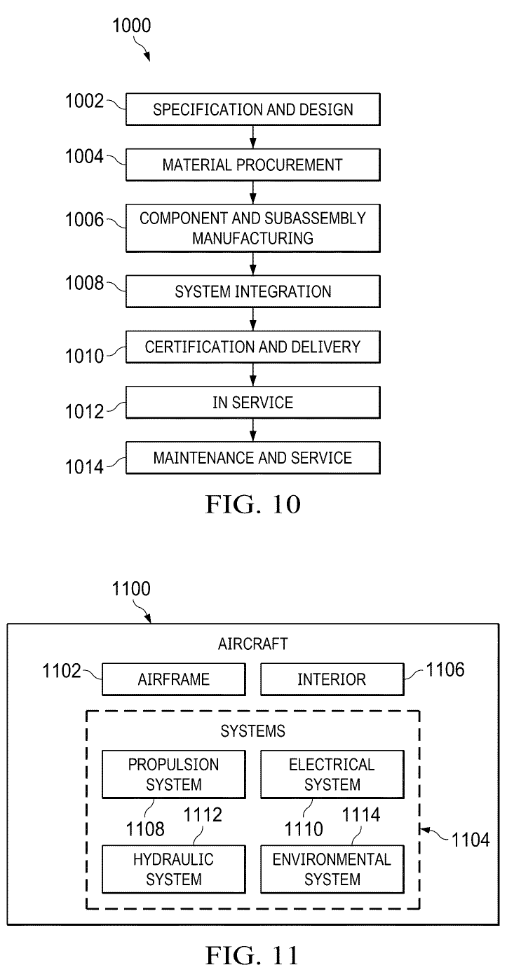

Illustrative embodiments of the present disclosure may be described in the context of aircraft manufacturing and service method 1000 as shown in FIG. 10 and aircraft 1100 as shown in FIG. 11. Turning first to FIG. 10, an illustration of an aircraft manufacturing and service method in a form of a block diagram is depicted in accordance with an illustrative embodiment. During pre-production, aircraft manufacturing and service method 1000 may include specification and design 1002 of aircraft 1100 in FIG. 11 and material procurement 1004.

During production, component and subassembly manufacturing 1006 and system integration 1008 of aircraft 1100 takes place. Thereafter, aircraft 1100 may go through certification and delivery 1010 in order to be placed in service 1012. While in service 1012 by a customer, aircraft 1100 is scheduled for routine maintenance and service 1014, which may include modification, reconfiguration, refurbishment, or other maintenance and service.

Each of the processes of aircraft manufacturing and service method 1000 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 11, an illustration of an aircraft in a form of a block diagram is depicted in which an illustrative embodiment may be implemented. In this example, aircraft 1100 is produced by aircraft manufacturing and service method 1000 of FIG. 10 and may include airframe 1102 with plurality of systems 1104 and interior 1106. Examples of systems 1104 include one or more of propulsion system 1108, electrical system 1110, hydraulic system 1112, and environmental system 1114. Any number of other systems may be included.

Apparatuses and methods embodied herein may be employed during at least one of the stages of aircraft manufacturing and service method 1000. One or more illustrative embodiments may be manufactured or used during at least one of component and subassembly manufacturing 1006, system integration 1008, in service 1012, or maintenance and service 1014 of FIG. 10.

The illustrative examples provide isothermal (constant or substantially constant mold temperature) processing while delivering the temperature ramp for resin chemistry to deliver a desired structural performance. The temperature profile during the process may be controlled and adjusted by manipulation of press closing. The parameters as well as mold portion temperatures are configured to deliver the cure cycle specific for the resin.

In some illustrative examples, the mold design detail can be adjusted to allow further adjust the heat transfer through the fiber part so full cure is achieved.

The illustrative examples can process resins with very high mechanical toughness. The illustrative examples can use a high performance resin while also delivering high output rates. The illustrative examples are able to reduce cost and increase throughput of aerospace parts.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of performing gap resin infusion comprising:
injecting a resin into a resin infusion chamber of a resin infusion mold comprising a first portion and a second portion while maintaining a temperature differential between the first portion and the second portion; and
forming an infused preform by forcing the resin into a dry fiber preform located in the resin infusion chamber while maintaining the temperature differential between the first portion and the second portion of the resin infusion mold.

2. The method of claim 1 further comprising:
removing the infused preform while maintaining the temperature differential.

3. The method of claim 1, wherein the resin infusion mold comprises at least one resin port.

4. The method of claim 3, wherein the first portion has a first temperature and the second portion has a second temperature, and wherein the first temperature is greater than the second temperature.

5. The method of claim 1, wherein maintaining the temperature differential comprises maintaining a first range of temperatures in a plurality of heating zones of the first portion.

6. The method of claim 1, wherein maintaining the temperature differential comprises maintaining a second range of temperatures in a plurality of heating zones of the second portion.

7. The method of claim 1 further comprising:
curing the resin in the infused preform while the infused preform is within the resin infusion chamber by maintaining the temperature differential.

8. The method of claim 1, wherein the temperature differential between the first portion and the second portion is set based on a type of resin.

9. A method of performing gap resin infusion comprising:
infusing a dry fiber preform with resin to form an infused preform by lowering a first portion of a resin infusion mold towards a second portion of the resin infusion mold while the first portion and the second portion are held at a temperature differential set based on a type of resin; and
holding the infused preform within the resin infusion mold while the first portion and the second portion are held at the temperature differential.

10. The method of claim 9, wherein holding the infused preform comprises:
heating the resin by a first temperature of the first portion and a second temperature of the second portion.

11. The method of claim 10, wherein the first temperature is greater than the second temperature.

12. The method of claim 9 further comprising:
injecting the resin into a resin infusion chamber of the resin infusion mold through a resin port located in the first portion of the resin infusion mold.

13. The method of claim 9, wherein the temperature differential comprises maintaining a first range of temperatures in a plurality of heating zones of the first portion.

14. The method of claim 9, wherein the temperature differential comprises maintaining a second range of temperatures in a plurality of heating zones of the second portion.

15. A method of performing gap resin infusion comprising:
infusing a first dry fiber preform with resin in a resin infusion mold while a first portion and a second portion of the resin infusion mold are held at a temperature differential to form a first infused preform;
removing the first infused preform from the resin infusion mold;
infusing a second dry fiber preform with resin in the resin infusion mold while the first portion and the second portion of the resin infusion mold are held at a second temperature differential to form a second infused preform; and
maintaining the temperature differential between the first portion and the second portion of the resin infusion mold between infusion steps.

16. The method of claim 15 further comprising:
holding the infused preform within the resin infusion mold while the first portion and the second portion are held at the temperature differential to increase tractability.

17. The method of claim 15 wherein the temperature differential comprises a difference between a first temperature of the first portion and a second temperature of the second portion, wherein further comprising:
introducing resin into a resin infusion chamber of the resin infusion mold through a resin port in the first portion of the resin infusion mold.

18. The method of claim 17, wherein the first portion is an upper mold portion and wherein the first temperature is greater than the second temperature.

19. The method of claim 15, wherein the temperature differential comprises maintaining a first range of temperatures in a plurality of heating zones of the first portion.

20. The method of claim 15, wherein the temperature differential comprises maintaining a second range of temperatures in a plurality of heating zones of the second portion.
